(19) United States
(12) Patent Application Publication
(10) Pub. No.: US 2017/0001328 A1
(43) Pub. Date: Jan. 5, 2017

(54) Circular Saw Guide

(71) Applicants: Gary Fiala, Wheaton, IL (US); Zachary Fiala, North Riverside, IL (US); Timothy Fiala, Brookfield, IL (US)

(72) Inventors: Gary Fiala, Wheaton, IL (US); Zachary Fiala, North Riverside, IL (US); Timothy Fiala, Brookfield, IL (US)

(21) Appl. No.: 14/788,502

(22) Filed: Jun. 30, 2015

(51) Int. Cl. B27B 9/04

(52) U.S. Cl. CPC B27B 9/04

(57) ABSTRACT

An apparatus and method for controlling a cut through a board by a hand-held circular power saw ensures safe and precise cross-cuts. A guide system includes two panels hinged together. A moveable panel is formed and folds into relationship with a grip panel. An edge of the saw baseplate contacts a guide edge of the grip panel for guiding the saw to make precise cuts without visual assistance or manually lining up the saw blade with a cut line.

### CROSS-REFERENCES TO RELATED APPLICATIONS

(Not Applicable)

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

1. Field of the Invention

This invention relates generally to hand-held power tools, and more specifically to a guide for a hand-held circular saws.

2. Description of the Related Art

Using a hand-held circular power saw is a challenging and dangerous task, and even an experienced carpenter can be challenged to make a straight cut that is perfect along a measurement line when cross-cutting any piece of lumber. A very large amount of lumber is cut with hand held power saws annually in the home construction and remodeling industries in the United States.

Circular power saws move freely, and, as a result are difficult to control, resulting in a high frequency of out of square cuts. Before actuating the saw, the user must first manually align the saw blade to the desired cut line on the lumber piece. Then, the user must attempt to saw along the line with restricted view of the saw blade as it cuts, due to the laterally-extending baseplate of the saw through which the saw blade protrudes for cutting. Moreover, there exists the well-known safety hazard commonly called ‘kickback’, whereby a saw blade is not accurately aligned on the work piece, and the misalignment results in a binding or pinching of the saw blade against the work piece, potentially causing a violent and dangerous backward movement of the tool.

The baseplate of the circular saw is the plate that makes contact with the wood surface while the saw cuts through the wood. The plate has a longitudinal aperture through which the saw blade protrudes for cutting, and adjacent plate sides extend laterally from each side of the saw cutting blade. Circular saws are considered to be either right handed or left handed, depending on which side of the saw blade has the smaller offset. The saw blade offset is defined as the distance from the cutting blade to either edge of the baseplate.

U.S. 2012 0255416 A1 by Rellergert is entitled “Circular Saw Guide” and discloses a circular saw guide with two guide members. One guide member is moveable relative to the other, and the two are connected by a sliding engagement. The guide is only used to measure a cut to a piece of lumber.

U.S. Pat. No. 8,047,113 B2 issued to Nilsen is entitled “Guide for Hand-Held Power Tool” and discloses a guide for a hand-held circular saw which has an elaborate attachment system for modifying a circular saw. This invention has an attachment to the saw itself as the saw is guided along the work piece. This invention requires elaborate time-consuming set up with each cut, because the guide must be attached to the work piece and to the circular saw before cutting.

U.S. Pat. No. 7,373,732 B2 issued to Baida is entitled “Attachable Guide for Circular Saw” also discloses a guide which is mounted to a circular saw. This invention utilizes a sliding attachment member and perpendicular bar. The sliding member adjusts the saw to a desired position relative to the work piece. It is unclear whether this invention will work with all circular saws.

U.S. Pat. No. 7,763,754 B1 issued to Glenn is entitled “Saw Blade Guide” discloses a power-tool guide mount assembly that attaches to a work piece. The saw guide has a guide plate that is movable on the mount assembly. This invention serves to allow the user to cut along a pre-determined cutting line.

After reviewing the literature, there exists a need in the industry for a circular saw cutting guide and a method for cross-cutting lumber that is quick, easy, economical, safe, and which does not wholly rely on a user to align and hold the saw blade on a cutting line. There also exists a need for a circular saw cutting guide that does not require modification of the saw.

### BRIEF SUMMARY OF THE INVENTION

The invention is a guide for hand held circular saws, having a moveable panel that rotates on a hinge connected to a stationary grip panel. Every circular saw has specific measurement between the cutting blade and either outside edge of the saw baseplate, right and left side, called an offset. This invention precisely calibrates the offset distance by initially cutting through the moveable panel. A disposable calibration spacer is attached to the stationary grip panel to accommodate the thickness of the moveable panel. Once the moveable panel is cut, the spacer is removed, and the invention is calibrated for that specific saw. After initial calibration is completed, the moveable panel rotates either 90 or 180 degrees, pivoting on a hinge. This rotation positions the moveable panel into a planar or perpendicular position relative to the stationary grip panel, and exposes a guide edge. The circular saw baseplate edge laterally contacts the guide edge for guiding the saw along the cutting line.

### BRIEF DESCRIPTION OF THE SEVERAL VIEWS OF THE DRAWINGS

FIG. 1 is a front view in perspective of the invention showing a dashed line marking where the moveable panel will form a permanent calibrated edge.

FIG. 2 is a front view perspective of the invention illustrating the calibrated saw cut edge on the moveable panel.

FIG. 3 is a is a front view in perspective of the invention showing the moveable panel in the perpendicular safety shield position to reveal the guide edge of the grip panel.

FIG. 4 is a front view in perspective of the invention showing the moveable panel resting in a planar position on the grip panel to reveal the guide edge.

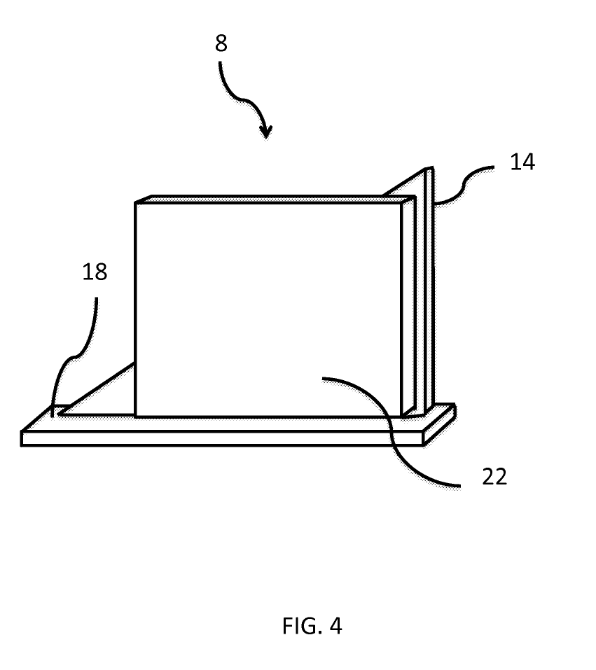

In describing the preferred embodiment of the invention which is illustrated in the drawings, specific terminology will be resorted to for the sake of clarity. However, it is not intended that the invention be limited to the specific term so selected and it is to be understood that each specific term includes all equivalents which operate in a similar manner to accomplish a similar purpose.

### DETAILED DESCRIPTION OF THE INVENTION

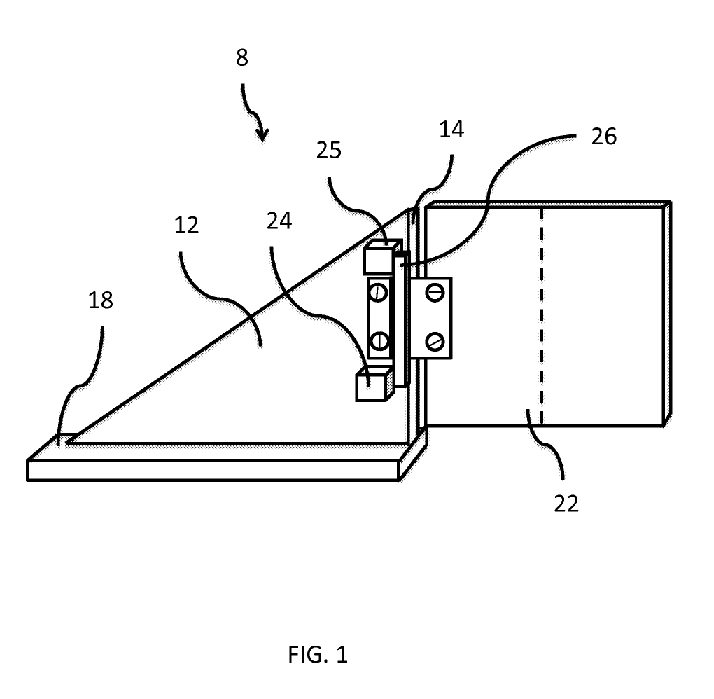

As seen in FIG. 1, the invention is a guide 8 for a hand-held circular saw. The guide 8 has a grip panel member 12 with an inside guide edge 14 and a bottom alignment edge 18. The bottom edge has a lip 18 for holding the guide 8 stationary on a work piece, such as any piece of standard lumber.

A moveable panel member 22 is connected to the grip panel 12 by a hinge adjacent to the guide edge 14. In the preferred embodiment, the hinges shown are fixed to the grip panel 12 on an area inward from the guide edge 14. Any such mechanical devices that work in the same manner as hinges can be utilized for allowing the pivoting rotation of the moveable panel 22 with respect to the stationary grip panel 12. But the spacing of any hinge must allow a protruding edge for guiding a saw.

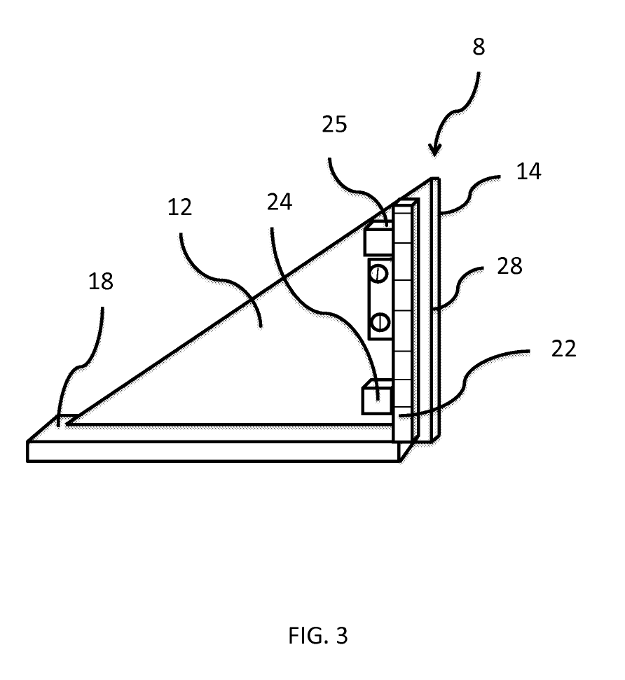

As seen in FIG. 3, spacer braces 24 and 25 hold the moveable panel 22 in a substantially perpendicular position with respect to the grip panel 12 as a protective shield for the user's hand.

The braces 24 and 25 can also be removed from the grip panel so that the moveable panel 22 can rotate to a stacked planar configuration onto the grip panel 12. In the stacked planar configuration position, the moveable panel 22 is again planar with respect to the grip panel 12, but the moveable panel 22 is stacked onto the grip panel 12. The stacked configuration of the panels 12 and 22 is necessary for removing the moveable panel 22 out of the path of a laterally-protruding motor found on some circular saw models.

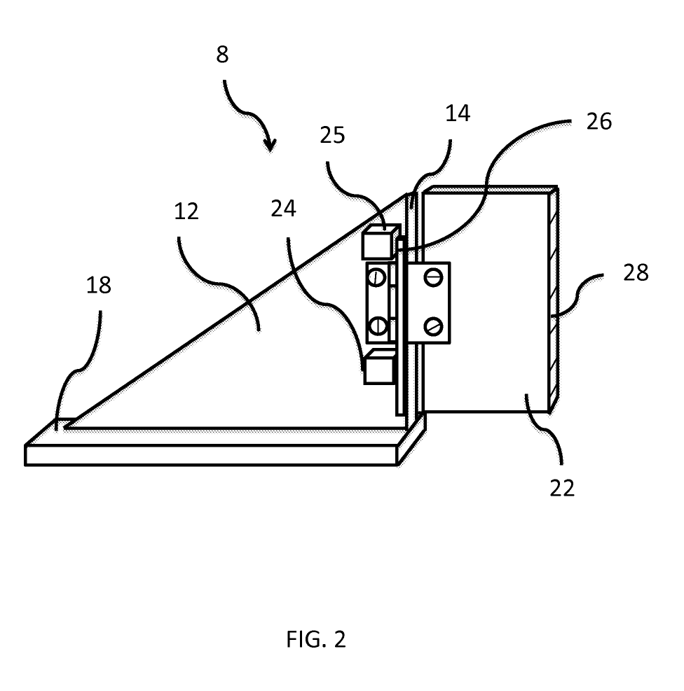

In FIG. 1, the braces 24 and 25 each have a means for receiving a spacer bar 26 on those planar sides. In the preferred embodiment, magnets are imbedded into the material used for the spacer braces 24 and 25 and the spacer bar 26, and they hold the bar 26 parallel to the guide edge 14 while the tool is being calibrated, after calibration, the spacer bar is discarded. As shown in both FIGS. 1 and 2, the guide 8 is in the first planar calibration position. The guide 8 is placed onto the work piece and the grip panel 12 is planar to the moveable panel 22.

When the moveable panel 22 is in the first planar calibration position, the spacer bar 26 is attached to the spacer braces 24 and 25. The circular saw is in lateral contact with the spacer bar 26. The user actuates the saw and applies forward force. The saw slowly moves from a first position to a second position along a line (shown in FIG. 1 as a dashed line) to cut the movable panel 22 into detached subparts and form an outside calibration edge 28 as shown in FIG. 2.

After the user finishes calibrating the guide 8 by the formation of the calibration edge 28, the guide 8 is ready to be used for cutting the work piece. The guide 8 is placed onto the work piece. The calibration edge 28 is used to draw a cutting line at a pre-determined location on the work piece, and then functions as the means to determine the exact offset dimension between the circular saw blade and the edge of the saw baseplate. The spacer bar 26, and braces 24 and 25, are removed from the grip panel 12 and set aside for use in the planar position. The moveable panel 22 is lifted upwardly, rotating on the hinge until the panel 22 is in a stacked planar position on the grip panel 12, as shown in HG. 4. The braces 24 and 25 remain in place for use as a stop and support for the moveable panel when used in the perpendicular safety shield position, as shown in FIG. 3.

The circular saw is positioned on the work piece, with an edge of the saw baseplate in lateral contact with the protruding inside guide edge 14 of the grip panel 12. Due to prior calibration, the blade is automatically laterally spaced directly onto the cutting line of the work piece, without a need for visual alignment by the user. The user holds the saw with an edge of the saw baseplate onto lateral contact with the guiding edge of the grip panel 12 as the saw moves from the first position to the second position relative to the work piece.

This method results in a precise separation of the work piece into subparts along the cutting line, without the need for the user to visually align the blade onto the cutting line. The guide 8 and method of use can be used with both right and left-handed circular power saws.

While certain preferred embodiments of the present invention have been disclosed in detail, it is to be understood that various modifications may be adopted without departing from the spirit of the invention or scope of the following claims.

We claim:

1. A guide for a circular saw, said guide comprising
(a) a grip panel member having a protruding guide edge and a hinge fixed to said grip panel adjacent to said guide edge;
(b) a moveable panel member connected to said grip panel by said hinge, so that said moveable panel adjustably moves from a first calibration position to a second cutting position;
(c) at least one removable spacer brace mounted to said grip panel a distance from said guide edge that is equal to the thickness dimension of said moveable panel;
(d) a removable spacer bar member mounted to said spacer brace parallel to said guide edge of said grip panel in said first planar calibration position, said spacer bar member thickness dimension being equal to said moveable panel thickness dimension, or even with the grip panel guide edge, and equal to said distance which said spacer brace is mounted from said inside edge of said grip panel;
Wherein when said moveable panel is in said first planar calibrated position said spacer bar is attached to said brace, an edge of a baseplate of said circular saw is in contact with said guide edge, and said saw moves from a first position to a second position relative to said moveable panel and said work piece, thereby separating said moveable panel and said work piece into detached subparts, and forming an outside calibration edge on said moveable panel; and, when said moveable panel is in said second cutting position said spacer bar and said spacer brace are removed from said grip panel and said edge of said baseplate of said circular saw is in contact with said guide edge, and said saw moves from said first position to said second position relative to said work piece, thereby separating said work piece into two discrete detached subparts.

2. The invention of claim 1, wherein said work piece is most dimensional sizes or types of lumber.

3. The invention of claim 1, wherein said spacer brace extends longitudinally a distance substantially the length of said inside edge of said grip panel.

4. A method for separating a piece of lumber or board into two detached subparts using a circular saw, said method comprising the steps of:
(a) placing a guide apparatus on an upper surface of a work piece so that the guide remains stationary with a work piece, said guide apparatus comprising:
(1) a grip panel member having an inside guide edge, a bottom alignment edge, and a lip on said alignment edge so that the guide remains stationary with a work piece;
(2) a moveable panel member connected by hinges to said guide edge of said grip panel, so that moveable panel adjustably moves from a first calibration position to a second cutting position;
(3) at least one spacer brace mounted to said grip panel a distance from said inside edge that is equal to the thickness dimension of said moveable panel and thickness of the hinge;
(4) a spacer bar member being detachably secured to said spacer brace parallel to said inside hinged edge of said grip panel in said first calibration position, said spacer bar member thickness dimension being equal to said moveable panel thickness dimension and hinge thickness, and equal to said distance which said spacer brace is mounted from said inside edge of said grip panel;
(b) Grasping and moving said moveable panel into said first planar calibrating position,
(c) Placing said circular saw onto said moveable panel and in lateral contact with said guide edge;
(d) Activating said circular saw;
(e) Moving said circular saw along said spacer bar from a first position to a second position relative to said moveable panel and said work piece while simultaneously and continuously applying pressure laterally against said guide edge and downwardly onto said moveable panel, thereby sawing through said moveable panel and said work piece and forming an outside calibration edge of said moveable panel;
(f) Deactivating said circular saw;
(g) Removing said spacer bar and said spacer brace from said grip panel;
(h) Aligning said outside calibration edge of said moveable panel to a desired position on said board;
(i) Marking a visible cutting line on said board;
(j) Grasping and moving said moveable panel into said second perpendicular or planar cutting position;
(k) Placing said circular saw onto said work piece and in lateral contact with said moveable panel guide edge;
(l) Reactivating said circular saw;
(m) Moving said circular saw from said first position to said second position relative to said work piece while simultaneously and continuously applying pressure laterally against said guide edge of said moveable panel and downwardly onto said work piece, so that said work piece is separated into two detached subparts.
